(19) United States
(12) Patent Application Publication
(10) Pub. No.: US 2016/0230702 A1
(43) Pub. Date: Aug. 11, 2016

(54) EXTENDED THRUST REVERSER CASCADE

(71) Applicant: UNITED TECHNOLOGIES CORPORATION, Hartford, CT (US)

(72) Inventors: Michael CHARRON, Baltic, CT (US); Robert L. GUKEISEN, Middletown, CT (US)

(73) Assignee: United Technologies Corporation, Hartford, CT (US)

(21) Appl. No.: 15/023,103

(22) PCT Filed: Sep. 12, 2014
(86) PCT No.: PCT/US14/55367

§ 371 Date: Mar. 18, 2016

Related U.S. Application Data
(60) Provisional application No. 61/879,876, filed on Sep. 19, 2013.

(51) Int. Cl. F02K 1/72; F02K 1/76

(52) U.S. Cl. CPC F02K 1/72; F02K 1/766; F05D 2240/129; F05D 2300/603

(57) ABSTRACT

A cascade set for creating sufficient drag to slow an aircraft is disclosed. The cascade set includes one or more supporting vanes. A plurality of turning vanes are connected to the supporting vanes, and the turning vanes include forward and aft turning vanes. The forward turning vanes have a larger surface area than the aft turning vanes.

### BACKGROUND

The present invention relates generally to gas turbine engines and, more particularly, to a cascade type thrust reverser for a gas turbine engine.

Modern aircraft turbofan engines have a nacelle or shroud surrounding the engine, spaced outwardly from a core engine cowl to define an annular passage or duct for flow of air rearwardly from the outer portion of a large fan or axial flow compressor. In this type of engine, a large proportion of the total thrust is developed by the reaction to the air driven rearward by the fan. The balance of the thrust results from ejection of the exhaust gas stream from the core engine.

Aircraft using gas turbine engines tend to have high landing speeds, placing great stress on wheel braking systems and requiring very long runways. Thrust reversers have been deployed in gas turbine engines to reduce braking stress and permit the use of shorter runways.

One type of thrust reverser is a cascade type thrust reverser. Gas turbine engines equipped with a cascade type thrust reverser utilize sets of cascade turning vanes in the sidewalls of the engine nacelle. A translating sleeve or cowl surrounds the cascade sets and forms a rearward outer wall portion of a bypass duct where bypass air flows between the nacelle and the core engine cowl. Upon deployment of the thrust reverser, the translatable sleeve moves rearwardly and blocking doors hinge radially inwardly to block the bypass duct and redirect bypass air flow through the cascade sets to an outlet. The direction of bypass air flowing through the cascade sets is substantially reversed, thereby slowing the aircraft's forward velocity. Bypass air is substantially reversed by contacting the turning vanes which comprise the cascade set. Normally each turning vane has the same surface area. Movement of the translating sleeve between a stowed forward position and a deployed rearward position may be provided by one or more actuators that extend between the nacelle and the translatable sleeve.

To contact the forward most turning vanes of the cascade set bypass air must make a very sharp turn. It is difficult to enable bypass air to turn sharp enough to contact the forward most turning vanes. As a result, a substantial amount of bypass air does not contact the forward most turning vanes of the cascade sets, and the thrust reverser operates less efficiently than it could. Accordingly, brake stress is increased and longer runways are required. In view of the foregoing problems, there is a need for improved cascade type thrust reversers that will operate more efficiently and help to create a sufficient amount of drag to slow an airplane.

### SUMMARY

An aircraft turbofan engine includes an engine nacelle that circumscribes an airflow duct, and a translating cowl that forms an aft portion of the engine nacelle. A cascade set is positioned within a gap between the translating cowl and the nacelle and has a plurality of vanes. Vanes disposed upstream relative to the flow of air have a greater surface area than vanes disposed downstream relative to the flow of air. The aircraft turbo fan engine also includes blocker doors that cover the cascade set when the translating cowl is in a stowed position, and blocks a portion of the airflow duct when the translating cowl is in a deployed position. Movement of the translating cowl to the deployed position rotates blocker doors, causing air to travel through the cascade set.

In another aspect, a thrust reverser system for an aircraft engine is disclosed. The system includes a translating cowl that has a stowed and a deployed position. A cascade set is positioned to be blocked when the translating cowl is in the stowed position and open when the translating cowl is in the open position. The cascade set has a plurality of vanes. Vanes disposed upstream relative to the flow of air have a greater surface area than vanes disposed downstream relative to the flow of air. The thrust reverser system also includes blocker doors that cover the cascade set when the translating cowl is in a stowed position. This causes air to bypass the cascade set.

In yet a further aspect, of the current invention a cascade set for creating sufficient drag to slow an aircraft is disclosed. The cascade set includes one or more supporting vanes. A plurality of turning vanes are connected to the supporting vanes, and the turning vanes include forward and aft turning vanes. The forward turning vanes generally have a larger surface area than the aft turning vanes.

### BRIEF DESCRIPTION OF THE DRAWINGS

FIG. 1A is a partial cross-sectional view of a gas turbine engine in cruising mode, e.g. during flight.

FIG. 1B is a partial cross-sectional view of the gas turbine engine in reverse thrust mode, e.g. during landing.

FIG. 2A is a partial cross-sectional view of annular thrust reverser duct of the engine of FIG. 1A shown in cruising mode.

FIG. 2B is a partial cross-sectional view of the annular thrust reverser duct of FIG. 2A shown in reverse thrust mode.

### DETAILED DESCRIPTION

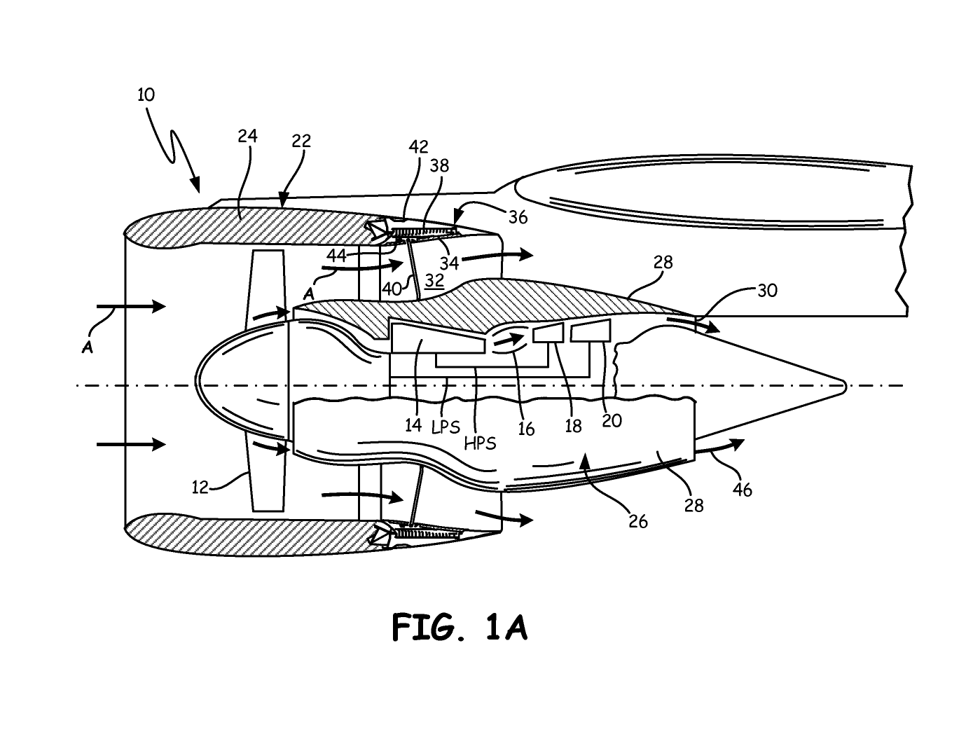

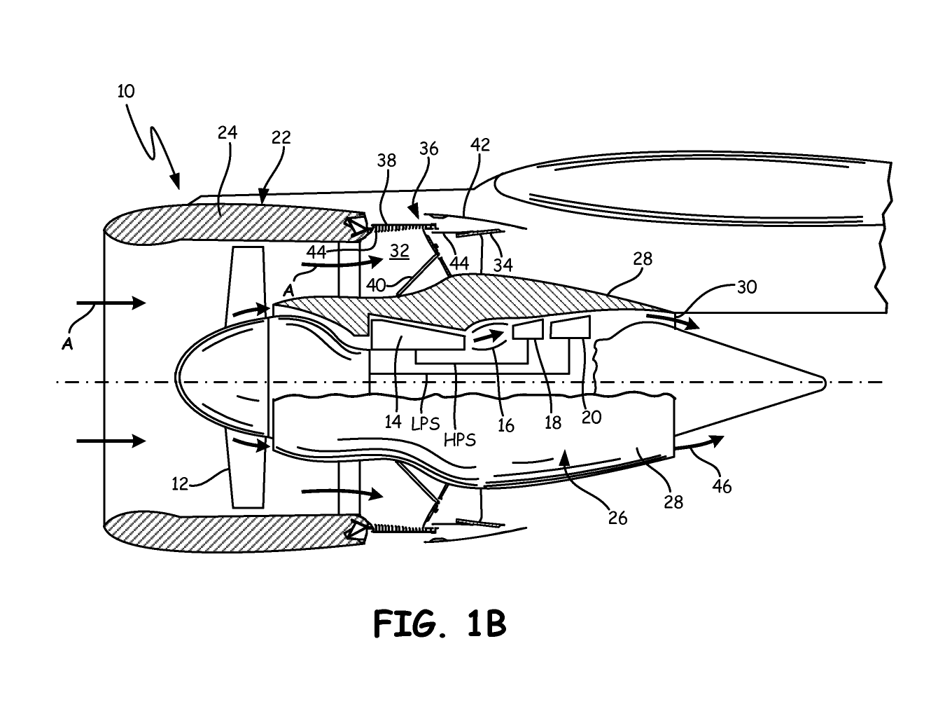

FIGS. 1A and 1B are partial cross-sectional views of gas turbine engine 10 which can be mounted to an aircraft. FIGS. 1A and 1B show gas turbine engine 10 in cruising mode and thrust reversing mode, respectively. Gas turbine engine 10 includes fan 12, multistage axial compressor 14, combustor 16, high pressure turbine 18, low pressure turbine 20, segmented cowl 22, nacelle body 24, engine core 26, inner fixed structure 28, core exhaust nozzle 30, bypass duct 32, blocker door 34, annular thrust reverser duct 36, cascade 38, drag link 40, translating cowl 42, and translating sleeve 44.

Engine core 26 and fan 12 are circumscribed by segmented cowl 22. Segmented cowl 22 includes nacelle body 24 and translating cowl 42, which is capable of rearward translation along the longitudinal axis of gas turbine engine 10. Axial movement of translating cowl 42 may be provided, for example by linear actuators (not shown). Disposed internally of segmented cowl 22 is translating sleeve 44 connected for movement with translating cowl 42. Located closer to the engine centerline is inner fixed structure (IFS) 28. IFS 28 is an outer surface of engine core 26. Bypass duct 32 is located between translating sleeve 44 and IFS 28 and through which air is forced by fan 12 for operation of gas turbine engine 10.

During operation, air A is pressurized in compressor 14 and mixed with fuel in combustor 16 for generating hot combustion gases 46 which flow through high and low pressure turbines 18, 20, respectively, that extract energy therefrom. High pressure turbine 18 powers compressor 14 through high pressure shaft (HPS) there between and low pressure turbine 20 powers fan 12 through low pressure shaft (LPS) there between.

Gas turbine engine 10 illustrated in FIGS. 1A and 1B is a high bypass ratio engine whereby most of the air pressurized by fan 12 is discharged from engine 10 through bypass duct 32, defined radially between IFS 28 of engine core 26 and nacelle 24 surrounding fan 12. Core exhaust gases 46 are discharged from engine core 26 through core exhaust nozzle 30.

Drag link 40 is primarily responsible for control in the deployment of blocker door 34 and is disposed within bypass duct 32. Drag link 40 is secured at one end to blocker door 34 and to IFS 28 at another end. Drag link 40 can be pinned to blocker door 34 or attached in any other suitable manner. Drag link 40 can be configured to slide along IFS 28. Drag link 40 can be shaped or contoured in such a way that when blocker door 34 moves from the stowed position shown in FIG. 1A to the deployed position shown in FIG. 1B, it adheres to the contour of IFS 28 or has clearance thereto. Drag link 40 can have a number of possible geometric configurations. Drag link 40 can be a smooth curve, bent, have multiple bends, or be straight. Drag link 40 being a smooth curve can be especially desirable as it can help reduce air drag through bypass duct 32 during cruising mode.

Annular thrust reverser duct 36 is disposed circumferentially adjacent and radially outward of bypass duct 32, defined between translating cowl 42 and translating sleeve 44. In cruising mode, e.g. during flight, as depicted in FIG. 1A, blocker door 34 lies generally contiguous with the surface of translating sleeve 44 and functions as a continuous extension thereof. Blocker door 34 is configured to mate and cooperate with a plurality of like blocker doors. When blocker door 34 is disposed in a mating engagement with like blocking doors, an annular ring is formed having a radius generally corresponding to the curvature of translating sleeve 44. In this orientation annular thrust reverser duct 36 is not in fluid communication with air flow A.

In reverse thrust mode, e.g. during landing, after touchdown, as depicted in FIG. 1B, annular thrust reverser duct 36 is in fluid communication with air flow A. To go from stowed to deployed, i.e., reverse thrust mode, translating cowl 42 translates axially rearward. Translating cowl 42 is usually moved using one or more suitable actuators (not shown) that can be a ball-screw actuator, hydraulic actuator, or any other actuator known in the art. As described above, translating sleeve 44 is connected to translating cowl 42 and also moves axially rearward. Blocking door 34 and drag link 40 are also responsive to the translation of translating cowl 42 and are moved into a deployed position. The movement of blocking door 34 is facilitated by the translation of drag link 40. Drag link 40 translates along IFS 28 as blocking door 34 pivots into bypass duct 32. Accordingly, bypass duct 32 is substantially blocked by a ring of blocker doors 34 interposed within bypass duct 32. The rearward translation of translating cowl 42 and translating sleeve 44 puts annular thrust reverser duct 36 in fluid communication with bypass air A. Therefore, bypass air A is effectively diverted to annular thrust reverser duct 36.

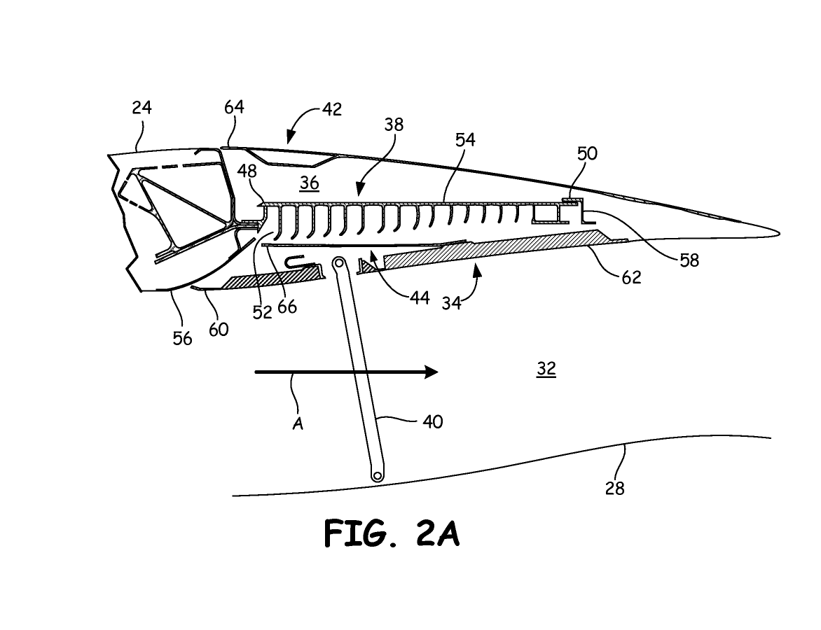

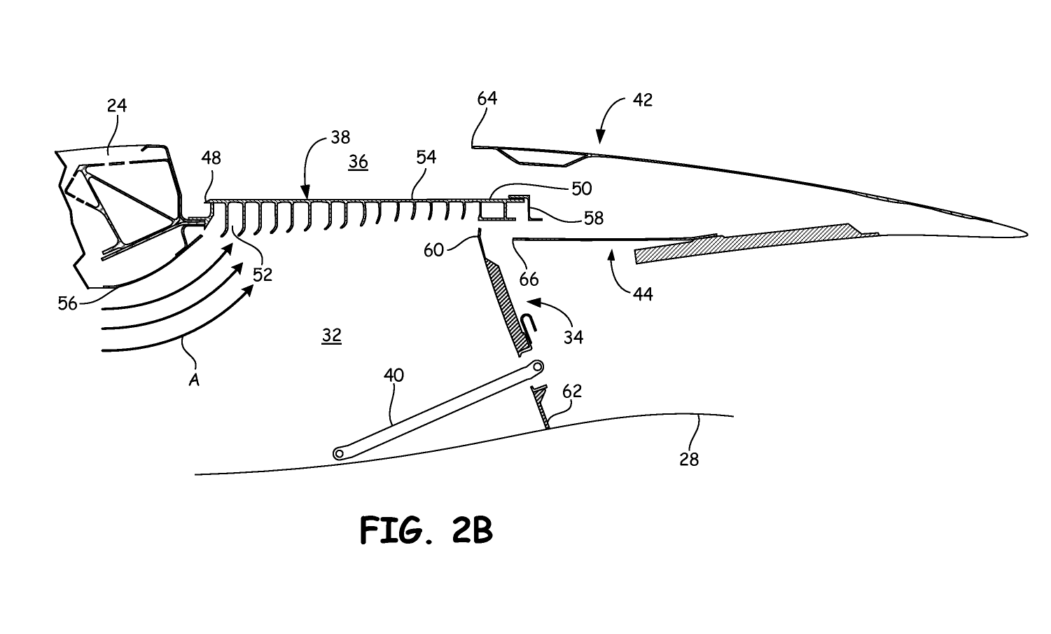

FIGS. 2A and 2B are partial cross-sectional views of annular thrust reverser duct 36 of FIGS. 1A and 1B shown in stowed mode and deployed, i.e., thrust reversing mode, respectively. Annular thrust reverser duct 36 includes cascade 38 having forward end 48, aft end 50, turning vanes 52, and support vane 54. Annular thrust reverser duct 36 further includes bullnose 56, aft cascade support ring 58. Blocker door 34 is also shown and includes forward edge 60 and back edge 62, drag link 40, translating cowl 42 having forward edge 64, and translating sleeve 46 having forward edge 66. Nacelle body 24, IFS 28, and bypass duct 32 are also shown.

In stowed mode, e.g., when cruising, bypass air A does not enter annular thrust reverser duct 36. As shown by FIG. 2A, forward edge 64 of translating cowl 42 is in contact with nacelle body 24, which would substantially block bypass air A from leaving annular thrust reverser duct 36. Forward edge 60 of blocking door 34 is substantially in contact with bullnose 56, substantially preventing bypass air A from entering annular thrust reverser duct 36. Because annular thrust reverser duct 36 is substantially blocked from bypass air A flow in cruising mode, bypass air A flows through bypass duct 32 and exits gas turbine engine 10 creating forward thrust.

In reverse thrust mode as shown in FIG. 2B, forward edge 64 of translating cowl 42 and forward edge 66 of translating sleeve 44 are translated axially rearward by an actuator (not shown) towards aft end 50 of cascade 38. As translating cowl 42 and translating sleeve 44 translate axially rearward, blocking door 34 pivots into bypass duct 32, the pivoting motion facilitated in part by drag link 40. After translation, forward edge 60 of blocking door 34 is disposed near aft cascade support ring 58. Back edge 62 of blocking door 34 extends radially towards and contacts IFS 28 effectively blocking bypass air A from flowing through bypass duct 32. As a result of the movement of translating cowl 42, translating sleeve 46, blocking door 34, and drag link 40, annular thrust reverser duct 36 is in fluid communication with bypass air A.

Cascade 38 is shown disposed within annular thrust reverser duct 36. Cascade 38 is disposed extending axially between bullnose 56 and aft cascade support ring 58. Bullnose 56 is fixed to nacelle body 24 and can be attached to the forward most turning vane 52 of cascade 38. Bullnose 56 can be aerodynamically configured to turn bypass air A toward turning vanes 52 disposed near forward end 48 of cascade 38. The configuration of bullnose 56 can also help direct bypass air A toward turning vanes 52 disposed near aft end 50 of cascade 38.

Aft cascade support ring 58 is fixed to nacelle body 24 and is attached to the aft portion of cascade 38. When in cruising mode as depicted by FIG. 2A, cascade 38 is disposed circumferentially adjacent and radially outward from translating sleeve 44, which is attached to blocker door 34 and connected for movement with translating cowl 42. Cascade 38 is also disposed circumferentially adjacent and radially inward from translating cowl 42. In reverse thrust mode as depicted in FIG. 2B, cascade 38 is not circumvented by either translating cowl 42 nor translating sleeve 44, and bypass air A can flow through cascade 38.

Cascade 38 can be made from a carbon composite or any other suitable material. Cascade 38 includes a plurality of vanes arranged as a matrix of turning vanes 52 and support vanes 54. Turning vanes 52 are disposed substantially perpendicular to the centerline of gas turbine engine 10 and support vanes 54 are disposed substantially parallel to the centerline of gas turbine engine 10. Turning vanes 52 can be curved with a forward aspect to divert air in a direction substantially reversed from its rearward flow through bypass duct 32.

Turning vanes 52 disposed toward forward end 48 of cascade 38 generally have a larger surface area than turning vanes 52 disposed toward aft end 50 of cascade 38. The difference in surface area can be the result of turning vanes 52, disposed toward forward end 48 extending radially longer than turning vanes 52 disposed toward aft end 50. The length of turning vanes 52 is limited by the distance between supporting vane 54 and translating sleeve 44. Although sixteen turning vanes 52 are depicted, more or fewer turning vanes can be employed in further embodiments without departing from the scope of the invention. Cascade 38 can be one of many cascade 38 matrices disposed within annular thrust reverser duct 36 circumferentially around gas turbine engine 10.

Turning vanes 52 disposed at forward end 48 of cascade 38 generally have a larger surface area than turning vanes 52 disposed at aft end 50 of cascade 38. The larger surface area of turning vanes 52 disposed at forward end 48 of cascade 38 can result in those turning vanes 52 being disposed closer to bypass air A than they would be if they had the same surface area as those turning vanes 52 disposed at aft end 50 of cascade 38. Accordingly, the generally larger surface area helps forward turning vanes 52 engage more bypass air A directed towards cascade 38 by bullnose 56. As turning vanes 52 engage bypass air A the direction of bypass air A is substantially reversed from it rearward path. Thus, drag sufficient to help slow an aircraft's forward velocity is created.

In view of the entirety of the present disclosure, including the accompanying figures, persons of ordinary skill in the art will recognize that the present invention can provide numerous advantages and benefits. For example, the ability of cascade 38 to engage more bypass air A can make cascade 38 more efficient than traditional cascades where every turning vane has a generally equivalent surface area. Because cascade 38 can engage more bypass air A, the ability of cascade 38 to create drag can be increased. This can help reduce braking stress and allow the use of shorter runways because the airplane will be able to stop quicker, while relying less on its brakes. Because cascade 38 can help an airplane stop quicker overall flight safety can be increased. Also, disposing turning vanes 52 closer to bypass air A allows the design of cascade 38 to have a shorter axial length than traditional cascade sets because turning vanes 52 can engage more air. A further benefit of cascade 38 is that it can be retrofit into annular thrust reverser duct 36 of any gas turbine engine or be built into any new gas turbine engine.

Any relative terms of degree used herein, such as “substantially”, approximately”, “essentially”, “generally” and the like, should be interpreted in accordance with and subject to any applicable definitions or limits expressly stated herein. In all instances, and relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, and the like.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

### Discussion of Possible Embodiments

The following are non-exclusive descriptions of possible embodiments of the present invention.

An aircraft turbofan engine can include an engine nacelle that circumscribes an airflow duct, and a translating cowl that forms an aft portion of the engine nacelle. A cascade can be positioned within a gap between the translating cowl and the nacelle and has a plurality of vanes. Vanes disposed upstream relative to the flow of air can have a greater surface area than vanes disposed downstream relative to the flow of air. The aircraft turbofan engine can also include a blocker door that covers the cascade set when the translating cowl is in a stowed position and that blocks a portion of the airflow when the translating cowl is in a deployed position, such that flow of air travels through the cascade set.

The aircraft turbofan engine of the preceding paragraph can optionally include, additionally and/or alternatively, any one or more of the following features, configurations and/or additional components. The vanes disposed upstream relative to the flow of air can be generally disposed closer to the air flow path than the vanes disposed downstream relative to the air flow path. Vanes of the plurality of the vanes can have different surface areas. The gas turbine engine can include a drag link that is connected to the blocker door, the drag link moving with the translating cowl as the translating cowl moves to the deployed position. The cascade set can be made of a composite carbon material. The vane disposed furthest upstream relative to the flow of air can be supported by a bullnose structure integrated to the engine nacelle. The cascade set can be a static structure disposed within the gap between the translating cowl and an engine nacelle. The plurality of vanes can engage the air flow and substantially reverse the generally rearward path of the air flow when the translating cowl is in a deployed position.

In another aspect, a thrust reverser system for an aircraft engine is disclosed. The system can include a translating cowl that can have a stored and a deployed position. A cascade set can be positioned to be blocked when the translating cowl is in the stowed position and open when the translating cowl is in the open position. The cascade set can have a plurality of vanes. Vanes disposed upstream relative to the flow of air can have a greater surface area than vanes disposed downstream relative to the flow of air. The thrust reverser system can also include a blocker door that covers the cascade set when the translating cowl is in a stowed position. The blocker door blocks a portion of the airflow duct when the translating cowl is in the deployed position such that the flow of air travels through the cascade set.

The thrust reverser system for an aircraft engine of the preceding paragraph can optionally include, additionally and/or alternatively, any one or more of the following features, configurations and/or additional components. The vanes disposed upstream relative to the flow of air can be generally disposed closer to the air flow path than the vanes disposed downstream relative to the air flow path. Vanes of the plurality of the vanes can have different surface areas. The thrust reverser system can include a drag link that is connected to the blocker door, the drag link moving with the translating cowl when the translating cowl moves to the deployed position. The cascade set can be made of a composite carbon material. The vane disposed furthest upstream relative to the flow of air can be supported by a bullnose structure integrated to an engine cover. The cascade set can be a static structure disposed within the gap between the translating cowl and the engine. The plurality of vanes can engage the air flow and substantially reverse the generally rearward path of the air flow when the translating cowl is in a deployed position.

In yet another embodiment, a cascade set for creating sufficient drag to slow an aircraft can include the following features. The cascade set can include one or more supporting vanes. A plurality of turning vanes can be connected to the supporting vanes, and the turning vanes include forward and aft turning vanes. The forward turning vanes can generally have a larger surface area than the aft turning vanes.

The cascade set of the preceding paragraph can optionally include, additionally and/or alternatively, any one or more of the following features, configurations and/or additional components. The turning vanes can have progressively smaller surface areas as they approach an aft end of the cascade set. The cascade set can be made of a composite carbon material. Finally, the forward most turning vane can be supported by a bullnose structure integrated to an engine nacelle.

1. An aircraft turbofan engine comprising:
an engine nacelle that circumscribes an airflow duct;
a translating cowl forming an aft portion of the engine nacelle, the translating cowl having a stowed position and a deployed position;
a cascade set positioned within a gap between the translating cowl and the nacelle and having a plurality of vanes, wherein the vanes disposed upstream relative to the flow of air have a greater surface area than the vanes disposed downstream relative to the flow of air; and
a blocker door that covers the cascade set when the translating cowl is in the stowed position such that the flow of air travels through the airflow duct and blocks a portion of the airflow duct when the translating cowl is in the deployed position such that the flow of air travels through the cascade set.

2. The aircraft turbofan engine of claim 1, wherein the vanes disposed upstream relative to the flow of air are generally disposed radially closer to the air flow path than the vanes disposed downstream relative to the air flow path.

3. The aircraft turbofan engine of claim 1, wherein vanes of the plurality of vanes have different surface areas.

4. The aircraft turbofan engine of claim 1, further comprising a drag link connected to the blocker door, the drag link moving with the translating cowl as the translating cowl moves to the deployed position.

5. The aircraft turbofan engine of claim 1, wherein the cascade set is made of a composite carbon material.

6. The aircraft turbofan engine of claim 1, wherein a vane disposed furthest upstream relative to the flow of air is supported by a bullnose structure integrated to the engine nacelle.

7. The aircraft turbofan engine of claim 1, wherein the cascade set is a static structure disposed within a gap between the translating cowl and the engine nacelle.

8. The aircraft turbofan engine of claim 1, wherein the plurality of vanes are positioned and shaped to engage the air flow and substantially reverse a generally rearward path of the air flow when the translating cowl is in a deployed position.

9. A thrust reverser system for an aircraft engine, the system comprising:
a translating cowl having a stowed position and a deployed position;
a cascade set positioned to be blocked when the translating cowl is in the stowed position and open when the translating cowl is in the deployed position, the cascade set having a plurality of vanes, wherein vanes disposed upstream relative to the flow of air have a greater surface area than vanes disposed downstream relative to the flow of air; and
a blocker door that covers the cascade set when the translating cowl is in the stowed position such that the flow of air travels through an airflow duct and blocks a portion of the airflow duct when the translating cowl is in the deployed position such that the flow of air travels through the cascade set.

10. The thrust reverser system of claim 9, wherein the vanes disposed upstream relative to the flow of air are generally disposed radially closer to the air flow path than the vanes disposed downstream relative to the air flow path.

11. The thrust reverser system of claim 9, wherein vanes of the plurality of vanes have different surface areas.

12. The thrust reverser system of claim 9, further comprising a drag link that is connected to the blocker door, the drag link moving with the translating cowl as the translating cowl moves to the deployed position.

13. The thrust reverser system of claim 9, wherein the cascade set is made of a composite carbon material.

14. The thrust reverser system of claim 9, wherein a vane disposed furthest upstream relative to the flow of air is supported by a bullnose structure integrated to an engine cover.

15. The thrust reverser system of claim 14, wherein the cascade set is a static structure disposed within a gap between the translating cowl and the engine cover.

16. The thrust reverser system of claim 9, wherein the plurality of vanes are positioned and shaped to engage the air flow and substantially reverse a generally rearward path of the air flow when the translating cowl is in the deployed position.

17. A cascade set for creating sufficient drag to slow an aircraft, the cascade set comprising:
one or more supporting vanes; and
a plurality of turning vanes connected to the one or more supporting vanes, the plurality of turning vanes including forward turning vanes and aft turning vanes, the forward turning vanes having a larger surface area than the aft turning vanes.

18. The cascade set of claim 17, wherein the turning vanes have progressively smaller surface areas as they approach an aft end of the cascade set.

19. The cascade set of claim 17, wherein the cascade set is made of a composite carbon material.

20. The cascade set of claim 17, wherein a forward most turning vane is supported by a bullnose structure integrated to an engine nacelle.
